(19) United States
(12) Patent Application Publication
(10) Pub. No.: US 2007/0064340 A1
(43) Pub. Date: Mar. 22, 2007

(54) Tape deflector having integrated roller

(75) Inventors: Michael A. Holmberg, Lafayette, CO (US); Amaninder S. Dhillon, Longmont, CO (US); Michael J. Vega, Longmont, CO (US)

Correspondence Address: MORRISON & FOERSTER LLP, 755 PAGE MILL RD, PALO ALTO, CA, 94304-1018, US

(73) Assignee: Quantum Corporation, San Jose, CA (US)

(21) Appl. No.: 11/234,775

(22) Filed: Sep. 22, 2005

(51) Int. Cl. G11B 15/00

(52) U.S. Cl. 360/95

(57) ABSTRACT

In one example a tape deflector assembly for use within a media drive is provided. The tape deflector assembly includes a tape deflector operable to selectively move and deflect a tape path away from a transducer head (e.g., to accommodate the passage of a leader and buckle mechanism thereby). The tape deflector includes a rotatable element operable to rotate in response to contact with an object (e.g., a leader or data storage tape) moving relative to the rotatable element. In one example, the tape deflector includes a movable arm, and the rotatable element is disposed at a distal end of the movable arm. The movable arm may rotate and/or translate to position the rotatable element and deflect the tape path. The assembly may further include a resilient member associated with the movable arm such as a spring loaded mechanism associated with the tape deflector.

### BACKGROUND

1. Field

This relates generally to storage media drives, and in one aspect to a magnetic storage media drive having a tape path deflector for avoiding or reducing the potential of contact between a buckle or cartridge/drive leader and the storage media drive head.

2. Description of Related Art

Tape drives are widely used for storing information in digital form. These tape drives commonly use a storage tape having a thin film of magnetic material which receives the information. Typically, the storage tape is guided with a plurality of tape guides between a pair of spaced apart reels, past a data transducer, also referred to herein as a tape head. The tape head records information onto the moving storage tape and/or reads information from the moving storage tape.

In one type of tape drive, one of the reels is part of the tape drive, while the other reel is part of a removable cartridge. For this type of tape drive, the reel that is a part of the tape drive is commonly referred to as a take-up reel, while the reel that is a part of the cartridge is commonly referred to as a cartridge reel. Typically, a cartridge leader on one end of the storage tape is automatically coupled to a drive leader that is connected to the take-up reel during insertion of the cartridge into the tape drive.

The cartridge leader and the drive leader are typically formed from materials that are more robust than the storage tape. Further, in one type of tape drive, a buckle formed from rigid materials such as metal or plastic is secured to the cartridge leader. The buckle engages the drive leader upon insertion of the cartridge into the tape drive. The procedure of connecting the drive leader to the cartridge leader is commonly referred to as buckling. Subsequently, during ejection of the cartridge, the cartridge leader is unbuckled from the drive leader.

During buckling and unbuckling, the buckle, the drive leader, and/or the cartridge leader pass in close proximity and may contact the tape head as they travel alone the tape path within the drive. This contact can cause excessive or premature wear to the tape head, or can permanently damage the tape head. Additionally, contact of the leader portions and/or buckle with portions of the drive or head may cause debris generation, which may clog the head leading to reduced performance or failure of the drive.

Additionally, electrostatic discharge (ESD) is a concern in the use of tape heads in tape drives, particularly in the case of magneto-resistive (MR) heads, which are typical in modern high-density tape technology. In some tape drives, the drive leader and/or the cartridge leader build up static charge from moving friction, thereby creating electrostatic discharge problems that can irreparably damage the tape head when the leaders come in contact with the tape head.

In light of the above, it is desired to provide a tape drive that protects the tape head from damage caused by contact with the buckle, tape drive leaders, and the like. It is further desired to provide a system that reduces or eliminates debris generation when guiding the buckle, drive leader, and cartridge leader by the tape head.

### BRIEF SUMMARY

In one aspect provided herein, an apparatus including a tape deflector assembly is provided. In one example, a tape deflector is operable to selectively move and deflect a tape path away from a transducer head, for example, to allow passage of a leader or buckle mechanisms by the transducer head. The tape deflector includes a rotatable element operable to rotate in response to contact with an object (e.g., a leader or data storage tape) moving relative to the rotatable element. In one example, the tape deflector includes a movable arm, and the rotatable element is disposed at a distal end of the movable arm. The movable arm may rotate and/or translate to position the rotatable element and deflect the tape path. The tape deflector may include a roller bearing assembly, wherein the rotatable element includes a roller. The assembly may further include a resilient member associated with the movable arm such as a spring loaded mechanism associated with the tape deflector.

According to another aspect provided herein, a storage media drive is provided. In one example, the media drive comprises a housing adapted to receive a storage cartridge having a supply reel with storage tape wound thereon, a drive leader and buckle mechanism adapted to engage a cartridge leader associated with the supply reel, a plurality of guide elements disposed to guide the storage tape across a transducer head along a tape path extending from the supply reel to the take-up reel, and a tape deflector having a rotatable element, the tape deflector operable to selectively deflect the tape path away from the transducer head. The rotatable element contacts the storage tape and rotates during deflection of the storage tape.

According to another aspect provided herein, a method for deflecting a tape path within a storage media drive is provided. In one example, the method comprises streaming one or more of a media drive leader, cartridge leader, and buckle mechanism along a path, the path passing adjacent a data transducer head. The method further includes deflecting the path away from the data transducer head with a tape deflector, the tape deflector comprising a rotatable surface operable to rotate in response to contact with one or more of the media drive leader, the cartridge leader, and the buckle mechanism when deflecting the path away from the data transducer.

The present invention is better understood upon consideration of the detailed description below in conjunction with the accompanying drawings and claims.

### BRIEF DESCRIPTION OF THE DRAWINGS

FIG. 1A illustrates a top view of an exemplary magnetic tape drive and magnetic tape cartridge;

FIG. 1B illustrates a top view of an exemplary head and tape deflector in an extended position;

FIG. 2 illustrates a partial view of an exemplary cartridge leader, drive leader, and buckle mechanism;

FIGS. 3A and 3B illustrate top views of the range of motion of an exemplary tape deflector assembly including a spring loaded arm in first and second positions;

FIGS. 4A and 4B illustrate perspective and exploded views of an exemplary tape deflector assembly; and

FIG. 5 illustrates an exemplary tape deflector with an integrated roller which selectively moves to deflect a tape path.

### DETAILED DESCRIPTION

The following description is presented to enable a person of ordinary skill in the art to make and use various aspects and examples of the invention. Descriptions of specific materials, techniques, and applications are provided only as examples. Various modifications to the examples described herein will be readily apparent to those skilled in the art, and the general principles defined herein may be applied to other examples and applications without departing from the spirit and scope of the invention. Thus, the present invention is not intended to be limited to the examples described and shown, but is to be accorded the scope consistent with the appended claims.

According to one aspect and example described herein, a storage media drive includes a tape deflector assembly for selectively deflecting a tape path through the media drive away from a transducer head. For example, the tape path may be deflected away from the transducer head during a cartridge loading process, when the cartridge leader, drive leader, and buckle pass adjacent the transducer head. Current tape deflectors and shutters, such as those in existing SDLT™ drives, for example, use static members that contact and deflect the tape and/or leaders away from the head. The static contact may generate debris within the media drive and scratch or damage the tape and/or tape leader. The debris may lead to build-up on the transducer head and may result in premature drive failure. Accordingly, the exemplary tape deflector provided herein includes a rotatable element, such as a roller bearing assembly or pin, disposed at the point of contact when deflecting the tape path (including the path of storage tape related tape components such as the cartridge/drive leaders, buckle mechanisms, etc. which travel along the tape path) away from the drive head. A non-static surface contact may reduce generated debris in the media drive (e.g., as would otherwise be caused by a static surface) and wear on the storage tape and related components. Additionally, the tape deflector may include a resilient or spring loaded mechanism to provide a desired tension to the tape path.

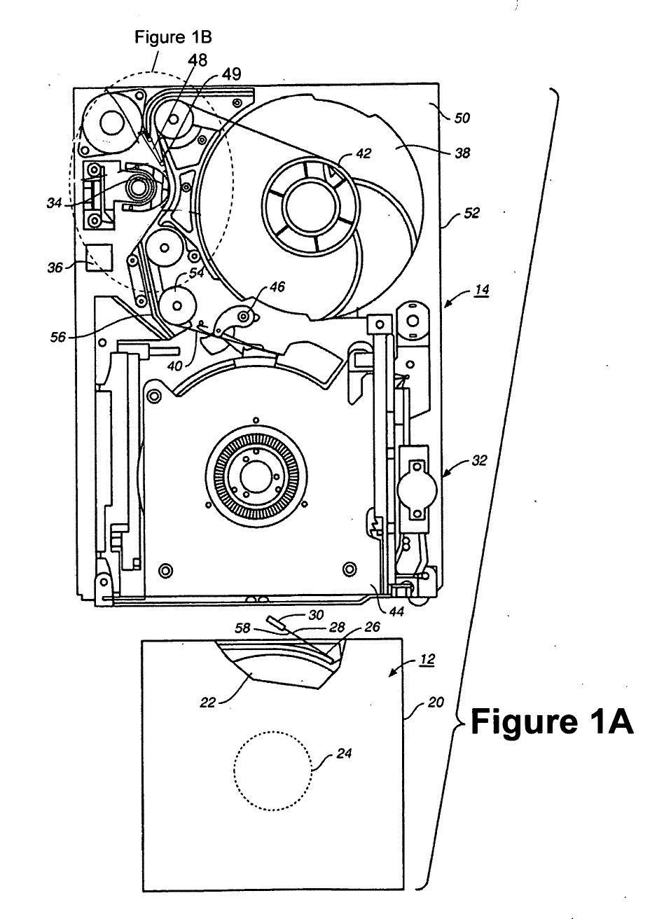

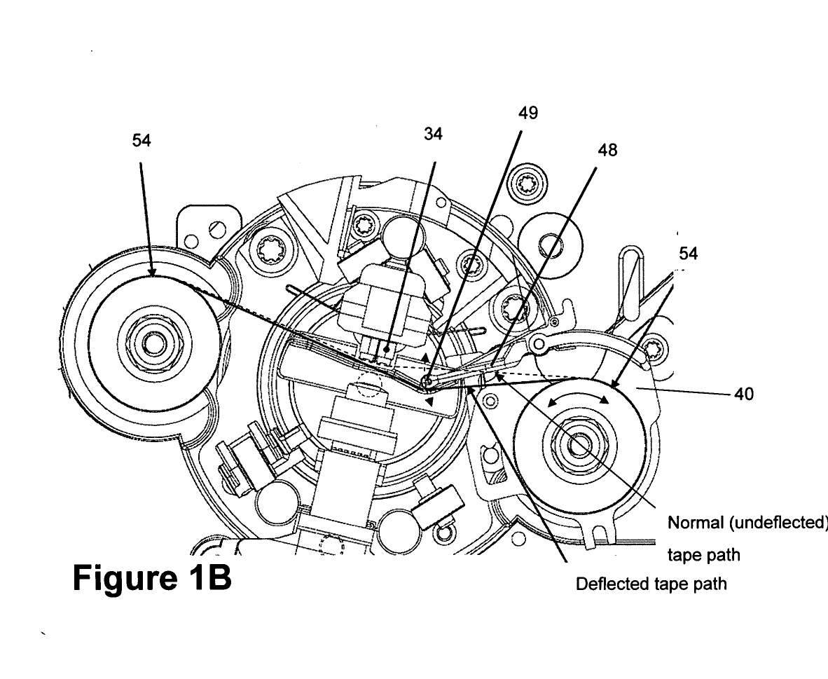

FIG. 1A illustrates a tape drive 14 and cartridge 12, where tape drive 14 includes a tape deflector 48 according to one example for deflecting a tape path away from a tape head 34. Cartridge 12 includes a cartridge housing 20, a cartridge reel 22 having a cartridge hub 24 (shown in phantom), a storage tape 26, and a cartridge leader 28 having a cartridge buckle component 30. The storage tape 26 is secured to the cartridge hub 24 on one end and the cartridge leader 28 on the other end. As illustrated in FIG. 1A, the cartridge 12 includes a single cartridge reel 22. In other examples (not shown), the cartridge can include two or more cartridge reels.

Tape drive 14 is typically installed within or associated with a computer (not shown) or computer network. Additionally, tape drive 14 may be used as part of an automated tape library having a plurality of tape cartridges and a robotic transfer mechanism to transport cartridges to one or more tape drives. An exemplary storage library is described in U.S. Pat. No. 5,760,995, entitled “MULTI-DRIVE, MULTI-MAGAZINE MASS STORAGE AND RETRIEVAL UNIT FOR TAPE CARTRIDGES,” which is hereby incorporated by reference in its entirety.

A representative magnetic tape drive for which an exemplary storage cartridge may be used is sold by Quantum Corporation under the trademark SDLT™ 320 or 600. Further, various examples herein are described with reference to magnetic tape drives; it will be understood by one of ordinary skill in the art, however, that the description of magnetic tape drives is illustrative only and the exemplary systems and methods are applicable to various data storage tape drives including, but not limited to, magnetic, optical, and magnetic/optical drive systems.

The tape drive 14 includes a drive housing 32, a tape head 34, a controller 36, a take-up reel 38 having a drive leader 40 and a take-up reel hub 42, a cartridge receiver 44, a buckler 46 and a tape deflector 48. The buckler 46 secures the drive leader 40 to the cartridge leader 28. The buckler 46 moves the drive leader 40 relative to the cartridge leader 28 to automatically buckle and/or unbuckle the drive leader 40 to the cartridge leader 28 in ways known to those skilled in the art.

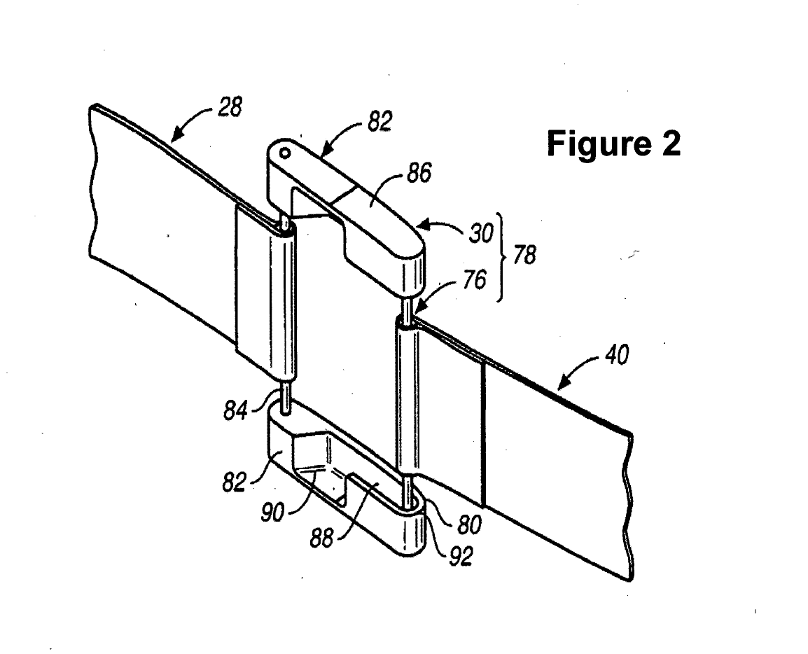

FIG. 2 illustrates one example of a drive leader 40 and the cartridge leader 28. A proximal end of the drive leader 40 is secured to the take-up reel hub (illustrated in FIG. 1A) of the take-up reel. The drive leader 40 includes a drive buckle component 76. The drive buckle component 76 and the cartridge buckle component 30 together form a buckle 78. A distal end of the drive leader 40 is bent around the drive buckle component 76 to secure the drive buckle component 76 to the drive leader 40. The drive leader 40 can include one layer of material, or can include multiple layers that are secured together. The material(s) utilized for each layers can be varied to suit the strength, flexibility and durability requirements of the drive leader 40. For example, each layer can be formed from polyethylene terephthalate (“PET”).

In the example illustrated in FIG. 2, the drive buckle component 76 includes a bar-shaped, buckle bar 80 which is secured to the drive leader 40. In the example illustrated, the buckle bar 80 is a substantially straight piece of a rigid material, having a substantially circular cross section. The buckle bar 80 extends transversely across the drive leader 40. The cartridge buckle component 30 includes a pair of spaced apart bar receivers 82 and a connector bar 84. Each bar receiver 82 is sized and shaped to receive a portion of drive buckle component 76 to couple the drive leader 40 to the cartridge leader 28. The use of two spaced apart bar receivers 82 ensures a reliable connection between the leaders 28, 40. In this example, the bar receivers 82 are secured together with the connector bar 84, which is attached to the cartridge leader 28. Each bar receiver 82 is defined by a substantially rectangular receiver housing 86. Each receiver housing 86 includes a channel 88 having a channel opening 90 and a channel end 92. During coupling, the buckle bar 80 is inserted into the channel opening 90. Subsequently, the buckle bar 80 is forced to slide in the channel 88 until the buckle bar 80 reaches the channel end 92.

The foregoing example of the drive leader 40 and the cartridge leader 28, which together include a buckle 78, is for illustrative purposes, and is not intended to limit the scope of the present invention in any manner. A detailed description and a number of alternate embodiments of the buckle 78 are illustrated and described in U.S. Pat. Nos. 6,092,754 and 6,311,915 issued to Rathweg, et al., and assigned to Quantum Corporation. Additionally, the drive leader 40 and the cartridge leader 28 may be buckled using other suitable designs such as those described in U.S. Pat. Nos. 4,662,049 and 4,720,913 issued to Hertrich, as non-exclusive examples. Each such embodiment and other suitable embodiments can be utilized with the present invention. The contents of U.S. Pat. Nos. 6,092,754, 6,311,915, 4,662,049 and 4,720,913 are all incorporated herein by reference.

With references again to FIG. 1A, the drive housing 32 retains various components of the tape drive 14. The drive housing 32 generally includes a base 50, four spaced apart side walls 52 and a cover (not illustrated for clarity). The tape drive 14 further includes a plurality of tape rollers 54 and tape guides 56 which are coupled to the drive housing 32. The tape rollers 54 and tape guides 56 guide the storage tape 26 along a tape path past the tape head 34 and onto the take-up reel 38. In the present example, the tape drive 14 includes three tape rollers 54 and two tape guides 56; however, the tape drive 14 may include any number of tape rollers 54 and/or tape guides 56.

The storage tape 26 can magnetically store data in digital form. The storage tape 26 includes a storage surface 58 on one side of the storage tape 26 for storing data. The storage surface 58 is divided into a plurality of tracks (not shown). Each track can be a linear pattern which extends the length of the storage tape 26. Alternately, for example, the data can be recorded in diagonal strips or other geometric configurations across the storage tape 26. Additionally, storage tape 26 may include an optical recording material in addition to or instead of a magnetic storage material for use with a suitable optical recording head in drive 14.

The controller 36 is in electrical communication with the tape head 34, and can direct electrical current to the tape head 34 for reading of data from and/or writing data to the storage tape 26. Further, the controller 36 can be utilized for selectively controlling movement of the tape deflector 48, as explained below.

FIG. 1B illustrates a partial view of tape drive 14 and exemplary tape deflector assembly 48 in greater detail. Tape deflector 48 selectively deflects the path of storage tape 26 away from tape head 34 (e.g., compare the undeflected outlined path with the deflected path), thereby eliminating or reducing the potential for contact between tape head 34 with components such as the drive leader 40, buckle mechanism 30, and/or the cartridge leader 28.

In this example, the tape deflector 48 includes a rotating surface element 49 at a distal end of deflector 48. Tape deflector 48 is rotatably attached to a base member 40, which rotates (as indicated by the arrow) about a common axis of rotation as roller 54. For example, counterclockwise rotation of base member 40 causes tape deflector 48 and rotating element 49 to rotate into the normal, undeflected tape path, thereby contacting and deflecting the tape path away from tape head 34 to a “Deflected tape path” position. Clockwise rotation of base member 40 retracts tape deflector 48 and rotating element 49 out of the tape path.

Tape deflector 48, in this example, further includes a spring loaded mechanism and may rotate relative to base member 40 (as indicated by the dotted arrow shown at rotating element 49). The spring loaded mechanism (or otherwise resiliency) of tape deflector 48 provides, for example, tension against the leader, buckle, and storage tape as they stream by. Additionally, a resilient deflector assembly may provide a more gentle and compliant deflection of tape 26 and the leader/buckle members than a stiff deflector arm, which may further reduce damage and debris generation. In other examples, a stiff tape deflector 48 and rotating element 49 may be used.

In one example, tape deflector 48 is selectively positioned to move the tape path away from the tape head 34 during a cartridge load or unloading process. In one example, the tape path is moved a sufficient distance to allow for the passage of the driver leader 40, cartridge leader 28, and buckle mechanism 30. These portions may have a greater thickness than storage tape 26 and the tape path is moved a sufficient distance to allow passage without contact to tape head 34. It should be understood that the term tape path as used in this context includes the path of the drive leader 40, cartridge leader 28, and buckle mechanism 30 as it travels through the tape drive 14 as well as the path of the actual storage tape 26.

Accordingly, tape deflector 48 may be positioned to alter the tape path and protect tape head 24. Additionally, the distal end of tape deflector 48 including rotating surface element 49 provides a rotating interface or surface contact with the drive leader 40, cartridge leader 28, buckle mechanism 30, and storage tape 26. Such an interface may reduce scratches and damage to the various components, and may also reduce debris generation with tape drive 14 compared with a static surface interfacing with the components in the tape path.

The design of tape deflector 48 and rotating surface element 49, including the dimensions and the materials used to form the deflector and rotating surface element 49 may be varied to suit the design and operating requirements of the tape drive 14, cartridge 12, and storage tape 26, and the like. In one example, the rotating surface element may include one or more of a metal, metal alloy, plated material(s), sputtered/over coated material(s), Teflon™, Teflon™ impregnated material(s), carbon impregnated material(s), plastic, ceramic, nylon, polycarbonate with carbon, or the like.

Additionally, various dimensions of the rotating element are possible and may depend on various factors such as the particular drive configuration, clearance distance, leader materials, buckle type, and the like. In one example, the rotating surface element has a diameter of approximately 2 mm and a length of approximately 12.5 mm. In other examples, the diameter of the rotating element may vary from approximately 1 mm to 4 mm and have a length of from approximately 10 mm to 15 mm. Of course, other dimensions are possible and contemplated.

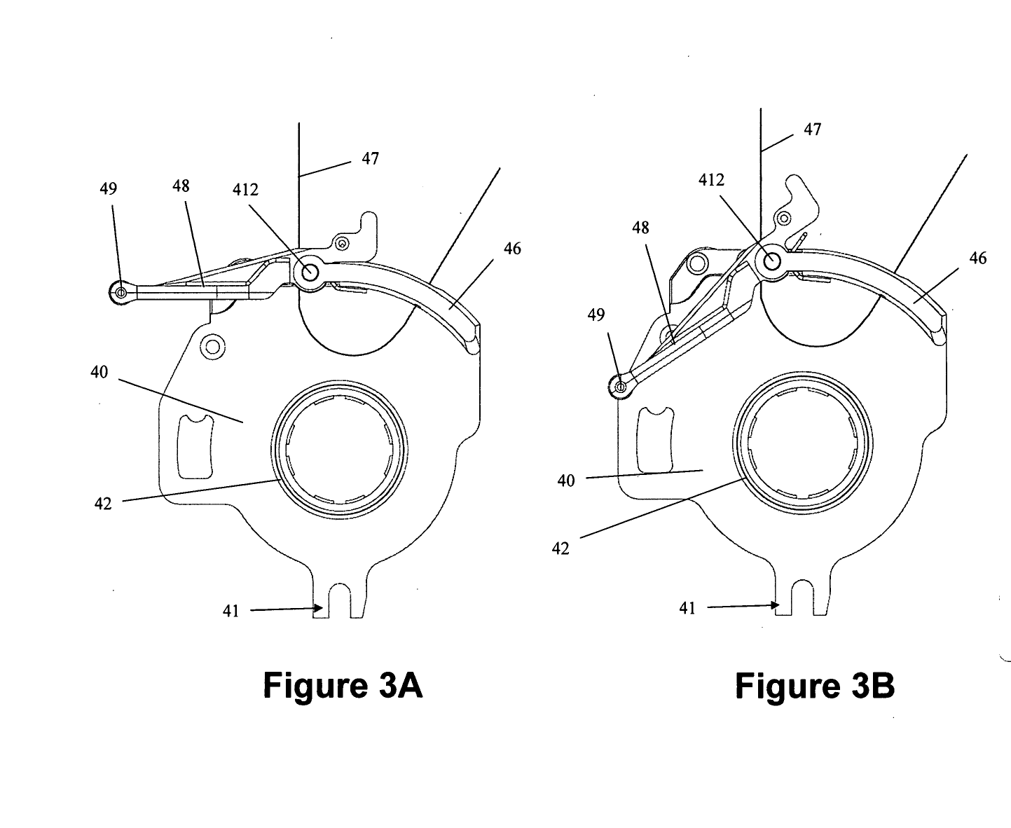

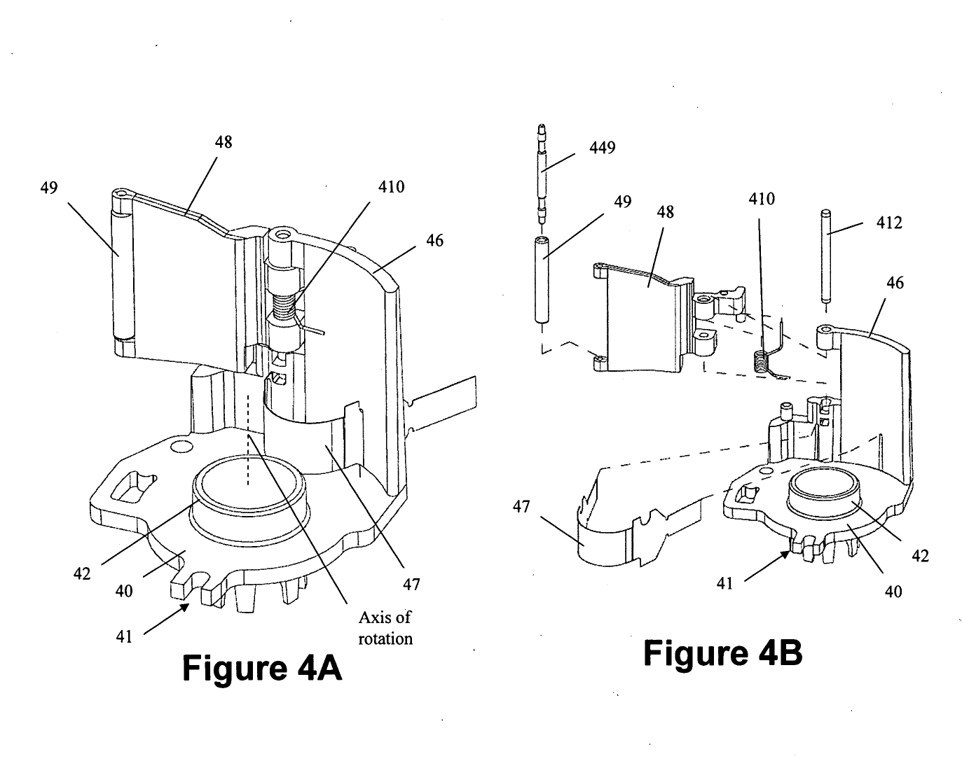

FIGS. 3A and 3B illustrate top views of an exemplary tape deflector assembly including tape deflector 48 and integrated rotating surface element 49 in first and second positions associated with the spring loaded mechanism. Additionally, FIGS. 4A and 4B illustrate a perspective and exploded view respectively of the tape deflector assembly and are referenced in conjunction with FIGS. 3A and 3B.

In this example, the tape deflector 48 is attached to base portion 40, which includes an upraised portion 46. As described above, base portion 40 may be rotatably mounted via bore 42. The entire assembly may be rotated about the axis of rotation (identified in FIG. 4A) via a motor acting, for example, on slot 41 to selectively position tape deflector 48 and rotating surface element 49 in the tape path. Any suitable motor or actuator may be used such as a stepper motor, voice coil motor, latching solenoid motors, brushless toy motors or the like.

In this example, tape deflector 48 is further rotatably mounted to portion 46 via a pin 412 (seen more clearly in FIGS. 4A and 4B) and is biased by, e.g., spring 410, thereby allowing tape deflector 48 and rotating surface element 49 to provide sufficient tension to the tape path and more gently accommodate the storage tape, leader portions, and buckle mechanism. In other examples, tape deflector 48 may be rigidly fixed to base member 40 or include other methods of providing spring loaded aspects described herein.

In one example, rotating surface element 49 includes a roller or sleeve mounted with a distal end of tape deflector 48 by a pin 449. Rotating surface 49 may include any suitable material for contacting the storage tape, leader portions, and buckle mechanisms; for example, comprises of, but not limited to, wear resistant materials such as ceramics, diamond like coating(s), as well as conductive materials suitable to provide ESD protection or materials such as a carbon impregnated hard plastic that provides a resistive path to ground.

In one example, pin 449 includes a spring bar, double flanged assembly made of stainless steel. Such a pin is manufactures by Comadur S A and sold as part no. 80531.215 and commonly used as a watch pin. It will be recognized, however, that various other pins and assemblies may be used.

It will be recognized that other methods for mounting a rotating surface element, such as rotating surface element 49 are possible and contemplated. For example, in some instances a rotating surface element may be mounted with a pin, fixed from a single end, or the like. Additionally, multiple rotating surface elements are possible, whether aligned longitudinally or laterally along the tape path. Further, multiple tape deflectors may be used; for example, a tape deflector including a rotating surface element could be positioned on both sides of tape head 34.

The deflector assembly may further include a tape support 47. Tape support 47 is positioned below a roller (not shown) mounted with bore 42, thereby providing support for storage tape, leaders, and a buckle mechanism during tension loss. Additionally, a suitable roller may be mounted with the deflector assembly, and specifically, with bore 42.

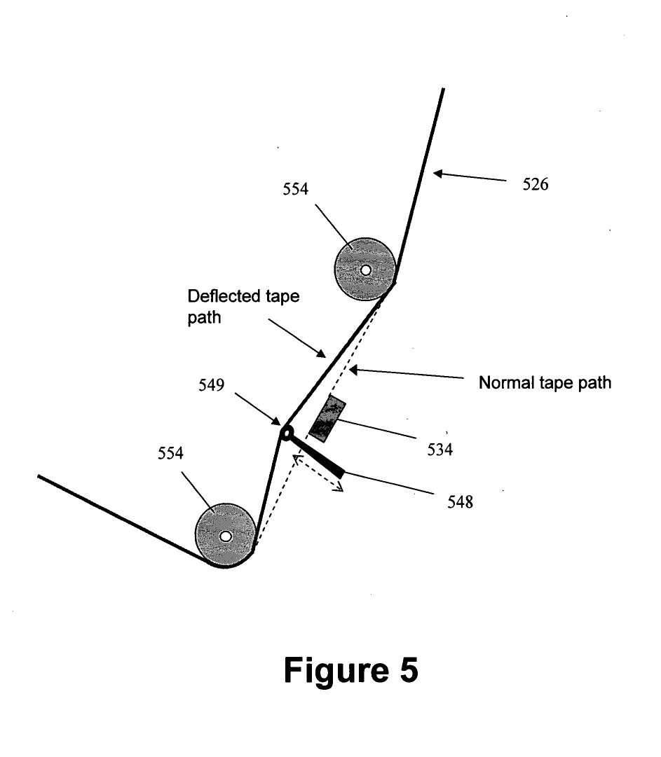

FIG. 5 illustrates an exemplary tape deflector with an integrated roller which selectively moves to deflect a tape path. This example is similar to that described with reference to FIGS. 1A and 1B, however, tape deflector 548, which includes a rotating surface element 549, is translated into a position to selectively deflect the tape path of storage tape 526 between rollers 554 and away from tape drive head 534.

Tape deflector 548 may include additional components, such as a base member and resilient or spring loaded mechanism similar to other examples provided. Additionally, combinations of rotational and translation motion of tape deflector 548 are possible; for example, where tape deflector 548 translates into position to deflect the tape path and includes rotational spring loaded mechanism to provide tension, for example.

In other examples a tape deflector may be moved normal to the plane of the tape path or at an angle to the plane of the tape path, as well as be rotationally moved into the plane of the tape path substantially normal or at other angles to the plane of the tape path. Further, multiple deflectors may be used on both sides of the magnetic recording head to deflect or lift the tape away from the head from both sides and may operate to do so simultaneously or at different intervals.

The above detailed description is provided to illustrate exemplary embodiments and is not intended to be limiting. It will be apparent to those of ordinary skill in the art that numerous modification and variations within the scope of the present invention are possible. For example, various exemplary methods and systems described herein may be used alone or in combination with various other media drive systems and related methods whether described herein or otherwise including, e.g., optical and/or magnetic media drive systems. Additionally, particular examples have been discussed and how these examples are thought to address certain disadvantages in related art. This discussion is not meant, however, to restrict the various examples to methods and/or systems that actually address or solve the disadvantages.

1. An apparatus for use with a storage tape drive, comprising:
a tape deflector operable to deflect a tape path away from a transducer head, wherein the tape deflector includes a rotatable element operable to rotate in response to contact with an object moving relative to the rotatable element.

2. The apparatus of claim 1, wherein the tape deflector includes a movable arm, and the rotatable element is disposed at a distal end of the movable arm.

3. The apparatus of claim 2, wherein the movable arm rotates to position the rotatable element to deflect the tape path.

4. The apparatus of claim 2, wherein the movable arm translates linearly to position the rotatable element to deflect the tape path.

5. The apparatus of claim 2, further including a resilient member associated with the movable arm.

6. The apparatus of claim 1, further including a spring loaded mechanism associated with the tape deflector.

7. The apparatus of claim 1, wherein the tape deflector includes a roller bearing assembly.

8. The apparatus of claim 1, wherein the rotatable element includes a roller.

9. A storage media drive, comprising:
a housing adapted to receive a storage cartridge comprising a supply reel having storage tape wound thereon;
a drive leader and buckle mechanism adapted to engage a cartridge leader associated with the supply reel;
a plurality of guide elements disposed to guide the storage tape across a transducer head along a tape path extending from the supply reel to the take-up reel; and
a tape deflector having a rotatable element, the tape deflector operable to selectively deflect the tape path away from the transducer head.

10. The storage media drive of claim 9, wherein the tape deflector includes a movable arm, and the rotatable element is disposed at a distal end of the movable arm.

11. The storage media drive of claim 9, wherein the tape deflector includes a roller bearing assembly.

12. The storage media drive of claim 9, wherein the rotatable element includes a roller.

13. The storage media drive of claim 9, wherein the tape deflector rotates into the tape path.

14. The storage media drive of claim 9, wherein the tape deflector translates into the tape path.

15. The storage media drive of claim 9, further including a controller, the controller comprising logic operable to initiate movement of the tape deflector to deflect the tape path.

16. The storage media drive of claim 15, wherein the controller further comprises logic to initiate movement of the tape deflector to deflect the tape path during load and unload operations.

17. A method for moving a data storage tape within a media drive, comprising:
streaming one or more of a media drive leader, cartridge leader, and buckle mechanism along a path, the path passing adjacent a data transducer head; and
deflecting the path away from the data transducer head with a tape deflector, the tape deflector comprising a rotatable surface operable to rotate in response to contact with one or more of the media drive leader, the cartridge leader, and the buckle mechanism when deflecting the path away from the data transducer.

18. The method of claim 17, wherein the tape deflector includes a movable arm, and the rotatable element is disposed at a distal end of the movable arm.

19. The method of claim 18, further including rotating the arm to position the rotatable element to deflect the path.

20. The method of claim 18, further including translating the arm to position the rotatable element to deflect the path.

21. The method of claim 18, further including a resilient member associated with the movable arm.

22. The method of claim 17, further including a spring loaded mechanism associated with the tape deflector.

23. The method of claim 17, wherein the tape deflector includes a roller bearing assembly.

24. The method of claim 17, wherein the rotatable element includes a roller.
